(19) United States
(12) Patent Application Publication
(10) Pub. No.: US 2022/0207439 A1
(43) Pub. Date: Jun. 30, 2022

(54) SYSTEM AND METHOD FOR ESTIMATING UTILIZATION OF INFORMATION TECHNOLOGY INFRASTRUCTURE ASSETS

(71) Applicant: LeanKloud Solutions LLC, Dover, DE (US)

(72) Inventors: Vasanth Balakrishnan, Chennai (IN); Vijay Ramachandran, Bangalore (IN)

(21) Appl. No.: 17/456,856

(22) Filed: Nov. 29, 2021

Related U.S. Application Data
(60) Provisional application No. 63/132,699, filed on Dec. 31, 2020.

(51) Int. Cl. G06Q 10/06

(52) U.S. Cl. CPC G06Q 10/0631

(57) ABSTRACT

The present invention relates to the field of management of Information Technology (IT) Infrastructure. The invention further relates to Information Technology Infrastructure assets, and to techniques for estimating utilization of IT Infrastructure assets. Particularly, the invention relates to method of estimation and computation of utilization of IT Infrastructure Assets, and to provide a reliable metric and a single unit of measurement for the determination of utilization of the asset derived from utilization parameters in the form of a monetary value. The system 100 for determining utilization of an Information Technology Infrastructure Asset, comprising computer hardware including at least one computer processor, memory (RAM) and a computer display; and a plurality of modules 102 include one or more modules for monitoring comprising a utilization parameter identification module, a utilization determination module, a utilization data collection module 103, a data analysis module 104 and a computation module.

### TECHNICAL FIELD

The present invention relates to the field of management of Information Technology (IT) Infrastructure. The invention further relates to Information Technology Infrastructure assets, and to techniques for estimating utilization of IT Infrastructure assets. Particularly, the invention relates to method of estimation of utilization of IT Infrastructure Assets, and to provide a reliable metric and a single unit of measurement for the determination of utilization of the asset derived from utilization parameters.

Additionally, the invention relates to application of the method for estimation and computation of utilization of IT Infrastructure Assets in the form of a monetary value.

### BACKGROUND ART

There are different ways of measuring utilization of IT Infrastructure Assets that are part of IT infrastructure landscape in any organization. These include percentage based utilization and credit based utilization (offered by Public Cloud service providers like AWS, Azure etc.) among others. These multiple measurements of utilization do not provide a normalized way to compare the utilization of IT Infrastructure Assets. On top of the multiple measurement techniques, multiple parameters including but not limited to memory (RAM), Central Processing Unit (CPU) cores, sometimes referred to as vCPUs (Virtual CPUs), network input output (Network I/O), disk input output per second (disk IOPS), disk throughput and disk/storage utilization are used in measuring utilization of different types of IT Infrastructure Assets. The process of measurement of utilization of these assets is complex given the different measurement techniques and different parameters involved leading to no single common measure of utilization being available today.

Some representative parameters that are typically part of the definition of utilization parameters of Virtual Machines, which is one type of IT Infrastructure Asset is given below.

a) CPU utilization

b) RAM utilization

This definition can be extended to include other IT Infrastructure Assets including but not limited to bare metal servers, databases and storage elements each of which could have any number of parameters that are used in measurement of its utilization in a similar way to the two representative parameters listed above for Virtual Machines. The process that is used to convert the different ways of measuring utilization and translating to a common monetary value can accommodate as many parameters as are measured for each IT Infrastructure Asset.

Some of the utilization measurement techniques involved in the IT infrastructure framework is:

a) Measurement in percentage terms to the original provisioned capacity (Example: Provisioned RAM=2 Gigabytes, utilization−50% means 50% of 2 Gigabytes which is 1 Gigabyte)

b) Measurement in credits utilized (Example: vCPU capacity credits available=6/hour (available credits), utilized is 2 credits in that hour (utilized credits), utilization in percentage is utilized credits/available credits*100 which is 2/6*100=33.33%)

There is no single unit of measurement of IT Infrastructure Asset utilization in the IT infrastructure framework, in the background art hitherto. Accordingly, there is a necessity to provide both a system and a method of determination of utilization of IT

Infrastructure Asset using a single unit of measurement.

### SUMMARY

The present invention allows normalizing different ways of measuring utilization of IT Infrastructure Assets. The invention particularly estimates utilization of IT

Infrastructure Assets by converting all the different measurements used and all parameters involved to a single measurement unit represented as a monetary value for easy interpretation and usage by organizations.

The process and the associated computation method proposed by the present invention helps normalize all the disparate ways of measuring utilization of IT Infrastructure Assets using multiple parameters and translate them into a single unit of measurement represented in the form of a monetary value, making it easy to interpret and use.

It is a primary aspect of the present invention to provide a method of determining utilization of IT Infrastructure Assets using a single unit of measurement that is translated to a monetary value.

It is another aspect of the present invention to provide a method of determining utilization of IT Infrastructure Asset using a single unit of measurement rather than multiple disparate units of measurement.

It is another aspect of the present invention to provide a method of determining the resource utilization for any given time period of an IT Infrastructure Asset using a single uniform metric or unit of measurement.

It is another aspect of the present invention to provide a single unit of measurement for utilization parameters to determine utilization of IT infrastructure assets.

It is another aspect of the present invention, wherein the method is also extendable to different statistical measures applied for determination of utilization of the IT Infrastructure Assets.

It is another aspect of the present invention to provide a method implementable for IT infrastructure asset elements including but not limited to bare metal servers, databases, storage elements and any other computing elements using the single measurement unit as a monetary value and further extendable to other IT infrastructure elements displaying similar behavior.

Thus according to the basic aspect of the present invention there is provided a system for determining utilization of Information Technology Infrastructure Assets, the system comprising:
computer hardware including at least one computer processor, memory (RAM) and a computer display; and a plurality of modules stored in computer-readable storage/database and comprising computer-readable instructions that, when executed by the computer processor, cause the computer hardware to perform operations defined by the computer-executable instructions; the modules including:
one or more modules for monitoring, comprising a utilization parameter identification module to identify one or more utilization parameters of the IT

Infrastructure Asset, and a utilization determination module for reading or measuring one or more utilization parameters of an IT Infrastructure Asset over predetermined time periods (n) real-time;
a utilization collection module that collects and stores all the utilization data of utilization parameters of an IT Infrastructure Asset in a machine readable storage element over predetermined time periods;
a data analysis module to analyze the data collected from the utilization parameters over the said predetermined (n) time periods to determine the chosen statistical measures of utilization of IT infrastructure Asset; and a computation module to estimate a Constraining Factor using utilization single parameter or a group of parameters of the Infrastructure Assets,
   wherein the utilization is computed based on application of statistical measures on the utilization parameters,
   wherein the computation module computes utilization of IT Infrastructure Assets from the Constraining Factor and converts/translates it to a monetary value, and
   wherein the system provides the same metric or unit of measurement for each IT Infrastructure Asset.

It is another aspect of the present invention to provide a system for determining utilization of IT Infrastructure Assets, wherein the predetermined time periods are time intervals “n” when the utilization data for utilization parameters is collected.

It is another aspect of the present invention to provide a system for determining utilization of IT Infrastructure Assets, wherein the Constraining Factor for the IT

Infrastructure Assets is derived from statistical measure for determination of utilization of the utilization parameters over the “n” time periods.

It is another aspect of the present invention to provide a system for determining utilization of IT Infrastructure Assets using statistical measures.

It is another aspect of the present invention to provide a system, wherein the IT Infrastructure Assets comprises virtual machines, bare metal servers, databases, storage elements and the like.

It is another aspect of the present invention to provide a method of determination of utilization of IT Infrastructure Assets, comprising the steps:
identifying of one or more utilization parameters defining the functioning of an IT Infrastructure Asset by a utilization parameter identification module; reading of the utilization parameters over predetermined time periods real-time or at sampling intervals by a utilization determination module;
analyzing of the data from various utilization parameters over the predetermined time periods by a utilization data collection module;
determining consumption/utilization of the IT Infrastructure Asset based on the statistical measure chosen for each utilization parameter by a data analysis module;
determining of Constraining Factor from the chosen statistical measure of utilization parameters over the predetermined time period; and computing of utilization as a product of Constraining Factor, the unit price (P) of the IT Infrastructure Asset and number of time periods (n) and expressed as a monetary value by a computation module.

It is another aspect of the present invention to provide a method of determination of utilization of IT Infrastructure Assets, wherein the utilization is computed from statistical measures applied on a single parameter or a group of parameters.

It is another aspect of the present invention to provide a method of determination of utilization of IT Infrastructure Assets by determining the Constraining Factor and presenting the utilization of the IT Infrastructure Asset using a single unit of measurement in the form of a monetary value.

### BRIEF DESCRIPTION OF DRAWINGS

FIG. 1 illustrates a block diagram depicting the translation of utilization of IT Infrastructure Assets to a monetary value.

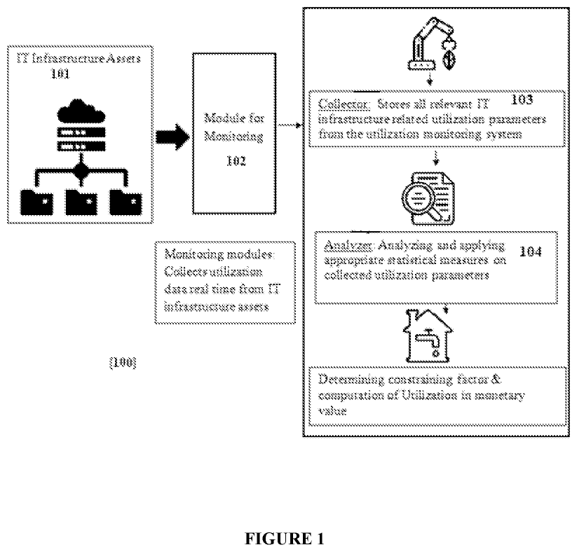

FIG. 2 illustrates the flowchart of the method of determining utilization of an Information Technology (IT) Infrastructure Assets.

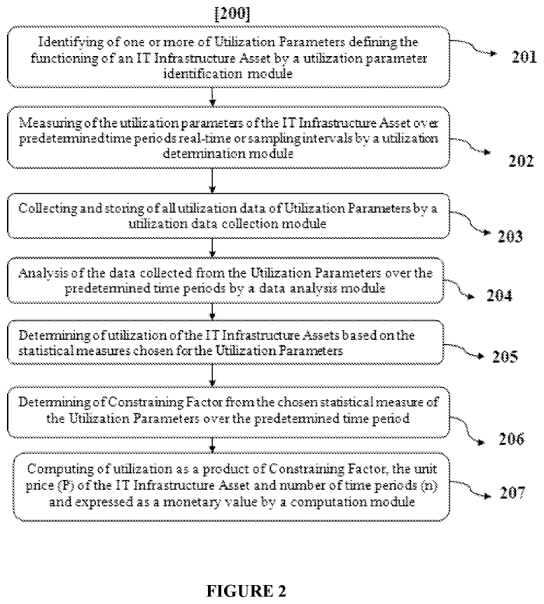

### DETAILED DESCRIPTION

Present invention relates to system and method for measuring utilization of IT Infrastructure Assets that are part of IT infrastructure landscape. Embodiments of the present invention relate to a system, and a method for estimating utilization of IT Infrastructure Assets by organizations using the said system.

Embodiments of the present invention relate to a method of estimation of utilization of IT Infrastructure Asset, wherein all the different ways of measuring utilization of the assets across multiple utilization parameters is translated to a single uniform metric or unit of measurement by determining the Constraining Factor.

In accordance with the aspects of the invention, the methods and systems of the present invention are advantageously operable and are designed to determine utilization of IT Infrastructure Assets and express as a single unit of measurement across all the disparate parameters, so that organizations can both interpret and use the assets effectively.

Definitions:

Utilization Parameters: One or more variables that are representative of the utilization of, and the load on various components that make-up the IT Infrastructure Asset.

Statistical Measure(s): Statistical Measure (s) according to embodiments of the present invention refers to the likes of, average, median, minimum, maximum or a combination of statistical measures like median of the maximum across all time periods, average of the maximum value across time periods under consideration. Statistical measure(s) also encompasses weighted measures of utilization of the utilization parameters.

Constraining Factor: Constraining Factor is a statistical measure of utilization of utilization parameters that anchors the translation of multiple disparate measurements and multiple different techniques of measurement of utilization to a single consistent unit of measurement.

IT Infrastructure Asset(s) or Asset(s): IT Infrastructure Assets comprises virtual machines, bare metal servers, databases, storage elements and the like

Terms “Infrastructure Asset(s)” and “Asset(s)” are interchangeably used in embodiments of the present invention.

An embodiment of the present invention discloses a system 100 for determining utilization of an Information Technology Infrastructure Asset, the system 100 comprising computer hardware including at least one computer processor, memory (RAM) and a computer display; and a plurality of modules 102 stored in computer-readable storage/database and comprising computer-readable instructions that, when executed by the computer processor, cause the computer hardware to perform operations defined by the computer-executable instructions. The modules 102 include one or more modules for monitoring comprising a utilization parameter identification module, a utilization determination module, a utilization data collection module 103, a data analysis module 104 and a computation module. The utilization parameter identification module is configured to identify one or more utilization parameters that define the functioning of, and load on/utilization of IT Infrastructure Assets 101. The utilization determination module is configured for reading or measuring the utilization parameters of an IT infrastructure asset 101 over predetermined time periods (n) real-time. The utilization data collection module 103 is configured to collect and store all the utilization data of an IT infrastructure asset 101 in a machine readable storage element over predetermined time periods (n). The data analysis module 104 is configured to analyse the data collected from various utilization parameters over the said predetermined (n) time periods to apply the chosen statistical measure of the consumption/utilization of the IT Infrastructure Assets 101 for each parameter.

The utilization is computed based on application of statistical measure on a single parameter or a group of parameters. The computation module is configured to estimate a Constraining Factor using utilization single parameter or a group of parameters of the Infrastructure Assets 101. The computation module computes overall utilization of IT Infrastructure Assets 101 from Constraining Factor and converts to a monetary value.

The system 100 provides the same metric or unit of measurement for all the utilization parameters.

Another embodiment of the present invention discloses a method 200 of determining utilization of IT Infrastructure Assets 101, comprising:

identifying 201 of one or more of Utilization Parameters defining the functioning of an IT Infrastructure Asset 101 by a utilization parameter identification module;

reading or measuring 202 of the utilization parameters of an IT Infrastructure Asset 101 over predetermined time periods real-time or sampling intervals by a utilization determination module;

collecting and storing of all utilization data of Utilization Parameters by a utilization data collection module 103;

analysing 204 of the data from Utilization Parameters over the predetermined time periods by a data analysis module 104;

determining 205 utilization of the Infrastructure Assets 101 based on the statistical measures chosen for the Utilization Parameters;

determining 206 of Constraining Factor from the chosen statistical measure of the Utilization Parameters over the predetermined time period; and

computing 207 of utilization as a product of Constraining Factor, unit price (P) of the IT Infrastructure Asset 101 and number of time periods (n) and expressed as a monetary value by a computation module.

According to an aspect of the present invention the utilization of IT Infrastructure Asset 101 is computed from statistical measures applied either on a single parameter or a group of parameters for determining utilization of the Infrastructure Assets 101.

According to another aspect of the present invention the statistical measure of Utilization Parameters is then translated to represent the utilization of the IT

Infrastructure Assets 101 as a single unit of measurement in the form of a monetary value.

Exemplary embodiment of the present invention discloses a method of estimating utilization of a Virtual Machine (VM) which is one type of IT Infrastructure Asset 101.

The application of the method for determination of utilization of VMs on an IT Infrastructure framework is described in detail below.

Each IT Infrastructure Asset 101 usually has a unit price “P” (price per hour, price per min, price per sec, price per day etc.) associated with it. The method according to exemplary embodiment of the present invention is enabled by the system 100 comprising:

computer hardware including at least one computer processor, memory (RAM) and a computer display; and

a plurality of modules 102 stored in computer-readable storage/database and comprising computer-readable instructions that, when executed by the computer processor, cause the computer hardware to perform operations defined by the computer-executable instructions.

The modules 102 include one or more modules for monitoring comprising a utilization parameter identification module, a utilization determination module, a utilization data collection module 103, a data analysis module 104 and a computation module. The utilization parameter identification module is configured to identify utilization parameters that define the functioning of, and load on VM's. The utilization determination module is configured for reading or measuring Utilization Parameters of VM' s over predetermined time periods (n) real-time. The utilization data collection module 103 is configured to collect and store all utilization data of VMs in a machine readable storage element over predetermined time periods (n). The data analysis module 104 is configured to analyse the data collected from various utilization parameters over the said predetermined (n) time periods like determining the applicable statistical measure of the VM's for each parameter. The computation module is configured to estimate a Constraining Factor using utilization of a single parameter or a group of parameters of the Infrastructure Assets 101.

The utilization is computed based on application of statistical measure on utilization parameters. The computation comprises estimation of a Constraining Factor from a chosen statistical measure of Utilization Parameters that define the utilization of the VM's. The computation module computes utilization of VM's from Constraining Factor and converts to a monetary value. The system 100 provides the same metric or unit of measurement across all the utilization parameters.

According to aspects of the present invention, the utilization parameters are all the parameters that are part of measurement of utilization and load on IT Infrastructure Assets, particularly discussed herein are representative parameters applicable to VMs. Implementation of the method uses “maximum” statistical measure in percentage terms to measure utilization of the VM and is further explained below
a) For example, if CPU utilization (say, statistical measure of “maximum”) and RAM utilization (say, statistical measure of “maximum”) were the two parameters defining a particular VM.
b) Both the parameters above were getting measured in percentage terms and let this data be collected and analyzed over “n” time periods.
c) Each time period will have one data point measuring maximum consumption (“period_max”) for each parameter in that period.
d) If CPU utilization were to be 75% (maximum of “period_max” across “n” time periods) and RAM utilization were to be 60% (maximum of “period_max” across “n” time periods), for this example particularly CPU utilization would considered to be the Constraining Factor for that VM.
e) If a utilization parameter is measured in the form of credits per unit time the invention looks at (utilized credits/available credits*100) in that unit time to determine the percentage utilization.

Aspects of the present invention can be extended more generically and if a VM has utilization defined/measured by parameters A, B, C and so on, this example detailing the invention looks at the most utilized parameter in percentage terms (“Constraining Factor”) and uses that for calculating monetary value of utilization of that VM.

Utilization is calculated as Constraining Factor multiplied by P multiplied by number of time periods “n”
a. Utilization of VM for “n” time periods=Constraining Factor*P*n The unit of utilization of VM is monetary (US Dollar, British Pound, Indian Rupee etc.)

Aspects of the present invention can also be extended to use other statistical measures of utilization (instead of “maximum”) like average, median and minimum or a combination of statistical measures like median of period_max across all time periods, average of the period_max across time periods under consideration and not limited to and still present the utilization of the VM using a single unit of measurement in the form of a monetary value.

Aspects of the present invention can also be extended to use weighted measures like weighted average of utilization across the utilization parameters like CPU utilization and RAM utilization to include multiple parameters in calculating Utilization of VM and still present the utilization of the VM using a single unit of measurement in the form of a monetary value.

It is to be understood that the present invention is exemplified using a Virtual Machine but its application cannot be confined to VM alone. Aspects of the invention can also be extended to measure utilization of other IT Infrastructure Asset elements including but not limited to bare metal servers, databases, storage elements and still present the utilization of the that particular asset type using a single unit of measurement in the form of a monetary value.

Representative uses for such a Common Measure of Utilization:

By presenting utilization as a monetary value, this makes possible a common measure that is easily understood by any organization that has disparate functions like Finance, Technology, Operations and Procurement with each function having its own unit of measure of utilization of VMs and other IT assets which comprise the IT infrastructure.

This monetary value of utilization can then be used as a common baseline for activities like structuring improvement in utilization of IT infrastructure, measuring performance with respect to IT infrastructure of different functions within an organization and measuring return on IT infrastructure asset at various abstraction levels (example : departments) in an organization.

Examples are based on Virtual Machine(s) (VM)

1. Example where statistical measure Maximum is used and all the utilization parameters are measured in percentage per unit time.
For example, if CPU utilization (say, statistical measure of “Maximum”) and RAM utilization (say, statistical measure of “Maximum”) were the two parameters defining a particular VM.
Both the parameters above are getting measured in percentage terms and if this data is being collected or analyzed over “n” time periods.
Each time period is having one data point (“period max”) for each parameter.
If CPU utilization were to be 75% (Maximum of “period_max” across “n” time periods—If there were 5 time periods in hours (n=5) and the period_max for CPU utilization in each of the time periods were 55%,56%, 57%, 65% &75%, Maximum of period_max would be 75% and if RAM utilization were to be 60% (Maximum of “period_max” across the same “n=5” time periods), this invention would then consider CPU utilization to be the constraining factor for that VM.
Utilization of VM (in monetary terms)=Constraining Factor*P*n where P is the price/time period.
Numerical example to calculate Utilization of VM using the above principle
   1. CPU utilization (Constraining Factor)=75%
   2. Let P=1 $/hour
   3. Number of time periods (n)=5
   4. Utilization of VM over this time period of 5 hours=75%*1*5=75/100*1*5=$3.75

2. Example where statistical measure Average is used where at least one of the utilization parameters is in “credits per unit time”.
If the CPU utilization were measured in the form of credits per unit time, this invention will look at (consumed credits/total available credits*100) in that unit time to determine the percentage utilization. Numerical example to illustrate Utilization of VM using CPU utilization in the form credits assuming P=1 $/hour
   1. Total credits available for use per hour=8
   2. Total credits used in 1^{st} hour=4
   3. Total credits used in 2^{nd} hour=2
   4. Total credits used in 3^{rd} hour=6
   5. Average CPU utilization of VM in percentage terms=(Total consumed credits=12)/Total credits available=24)*100=50%
With CPU utilization at 50% (Average across 3 time periods, where time period in this example is in hours) and RAM utilization were to be 40% (Average of “period avg” across 3 (three) time periods, where “period avg” is the average utilization within that period), this invention would then consider CPU utilization to be the constraining factor for that VM.
   1. Utilization of VM (in monetary terms)=Constraining Factor*P*n where P is the price/time period
   2. CPU utilization (Constraining Factor)=50%
   3. Let P=1.0 $/hour
   4. Number of time periods (n)=3
   5. Utilization of VM (in monetary terms) over the 3 time periods=50% *1.0*3=50/100*1.0*3=$1.5

3. Example where statistical measure Maximum of each period's Average is used where the measure of utilization across all parameters is in percentage per unit time
For example, if CPU utilization (say, statistical measure of “Average”) and RAM utilization (say, statistical measure of “Average”) were the two parameters defining a particular VM.
Both the parameters above were getting measured in percentage terms and if this data is being collected or analyzed over “n” time periods.
Each time period is having one data point (“period_avg”) for each parameter.
Maximum of period_avg is to be used for determining parameter's utilization
If CPU utilization were to be 80% (Maximum of “period_avg” across “n” time periods) and RAM utilization were to be 40% (Maximum of “period_avg” across “n” time periods), this invention would then consider CPU utilization to be the constraining factor for that VM.
Utilization of VM (in monetary terms)=Constraining Factor*P*n where P is the price/time period.
   1. Numerical example to calculate Utilization of VM using the above principle
   2. CPU utilization (Constraining Factor)=80%
   3. Let P=0.10 $/hour
   4. Let number of time periods (n)=24
   5. Utilization of VM over 24 time periods=80%*0.10*24=80/100*0.10*24=$1.92

4. Example: This concept is extended to use a weighted measure like weighted average of utilization across multiple utilization parameters like CPU utilization and RAM utilization to include multiple parameters in calculating Utilization of VM.
For example, if CPU utilization (say, statistical measure of “Average”) and RAM utilization (say, statistical measure of “Average”) were the two parameters defining a particular VM.
Both the parameters above were getting measured in percentage terms and if this data is being collected or analyzed over “n” time periods.
Based on nature of usage, a weightage could be associated to different utilization parameters while arriving at overall utilization of VM. A weightage of 60% is associated with RAM utilization and a weightage of 40% is associated with CPU. The total weightage should add upto 100% if assigning weights to different parameters.
Each time period is having one data point (“period_avg”) for each parameter. Maximum of period_avg is to be used for determining parameter's utilization in this example.
If CPU utilization were to be 80% (Maximum of “period_avg” across “n” time periods) and RAM utilization were to be 40% (Maximum of “period_avg” across “n” time periods), this invention could then use a Constraining Factor that is a combination of RAM and CPU utilization based on the weightages associated with it. In this case, the computation would be
   1. Constraining Factor=((weightage of CPU utilization*CPU Utilization)+(weightage of RAM utilization*RAM utilization))/100.
   2. Constraining Factor=((40%*80%)+(60%*40%))=56%
Utilization of VM (in monetary terms)=Constraining Factor*P*n where P is the price/time period.
Numerical example calculate Utilization of VM using the above principle
   1. Constraining Factor=56%
   2. Let P=0.10 $/hour
   3. Let number of time periods (n)=24
   4. Utilization of VM over 24 time periods=56%*0.10*24=56/100*0.10*24=$1.344

If the concept is to be extended more generically, if a VM has utilization defined by parameters A (Util_A), B (Util_B) and so on, the present invention looks at Constraining Factor and uses that for calculating the monetary value of utilization of that VM. The above concept is extended to other categories of assets like Storage, Databases etc. Each asset (like a Storage Volume) has its own utilization parameters such as A (Util_A), B (Util B) and so on. The present invention looks at Constraining Factor and uses that for calculating the monetary value of utilization of that particular asset. The concept is further extended to calculate monetary value of utilization of asset classes like a set of VMs, a set of storage volumes and so on. The concept is extensible to use other statistical measures of utilization like:
1. average, median and minimum or a combination of statistical measures like median of period_max across all time periods, average of the period_max across time periods under consideration or
2. Percentile usage (average utilization for 99% of time, maximum utilization for 99% of time).

The statistical measure used for defining Constraining Factor is defined by the user and represents a trade-off between cost and performance acceptable for that particular asset.

The Utilization is calculated as Constraining Factor multiplied by P multiplied by number of time periods “n”
a. Utilization of VM for n time periods=Constraining Factor*P*n The unit of Utilization of VM would be monetary (US Dollar, British Pound, Indian Rupee etc.).

The unit cost of a VM, “P”, is typically available
Via the price catalogue in case of Public Cloud Service providers like AWS and Azure.
Within the finance team of the organization for which Utilization of VM is being computed, in case an IT server (from which one or more VMs can be spun up) has been purchased. This information is generally stored in the organization's Enterprise Resource Planning (ERP) system or a database that stores financial information related to IT infrastructure.

Although, the invention has been described and illustrated with respect to the exemplary embodiments thereof, it should be understood by those skilled in the art that the foregoing and various other changes, omissions and additions may be made therein and thereto, without parting from the spirit and scope of the present invention.

What is claimed is:

1. A system 100 for determining utilization of an Information Technology (IT) Infrastructure Asset, the system comprising:
computer hardware including at least one computer processor, memory (RAM) and a computer display;
a plurality of modules 102 stored in a computer-readable storage/database and comprising computer-readable instructions that, when executed by the computer processor, cause the computer hardware to perform operations defined by the computer-executable instructions;
one or more modules 102 for monitoring comprising:
a utilization parameter identification module to identify one or more utilization parameters of one or more IT Infrastructure Assets 101 that define the functioning of, and load on IT Infrastructure Assets 101;
a utilization determination module for reading or measuring one or more utilization parameters of an IT infrastructure asset 101 over predetermined time periods (n) real-time;
a utilization data collection module 103 that collects and stores all the utilization data of utilization parameters of the IT infrastructure asset 101 in a machine readable storage element over predetermined time periods;
a data analysis module 104 to analyse the data collected from the utilization parameters over the said predetermined time periods to determine the chosen statistical measures of the consumption/utilization of the IT Infrastructure Assets 101 for each parameter; and
a computation module to estimate a Constraining Factor using utilization single parameter or a group of parameters of the Infrastructure Assets 101,
wherein the utilization is computed based on application of the statistical measure on a single utilization parameter or a group of utilization parameters,
wherein the computation module computes overall utilization of IT Infrastructure Assets 101 from the Constraining Factor and converts/translates it to a monetary value, and
wherein the system 100 provides the same metric or unit of measurement for all the utilization parameters.

2. The system 100 for determining utilization of an Information Technology (IT) Infrastructure Asset as claimed in claim 1, wherein the predetermined time periods are time intervals “n” when the utilization data for utilization parameters is collected.

3. The system 100 for determining utilization of an Information Technology (IT) Infrastructure Asset as claimed in claim 1, wherein the Constraining Factor for the IT Infrastructure Assets 101 is a derived statistical measure for determination of utilization of the utilization parameters over the “n” time periods.

4. The system 100 for determining utilization of an Information Technology (IT) Infrastructure Asset as claimed in claim 1, wherein the IT Infrastructure Assets 101 comprises of virtual machines, bare metal servers, databases, storage elements and the like.

5. A method 200 of determining utilization of an Information Technology (IT) Infrastructure Assets, comprising:
identifying 201 of one or more of Utilization Parameters defining the functioning of an IT Infrastructure Asset 101 by a utilization parameter identification module;
measuring 202 of the utilization parameters of the IT Infrastructure Asset 101 over predetermined time periods real-time or sampling intervals by a utilization determination module;
collecting and storing 203 of all utilization data of Utilization Parameters by a utilization data collection module 103;
analysis 204 of the data collected from the Utilization Parameters over the predetermined time periods by a data analysis module 104;
determining 205 of utilization of the IT Infrastructure Assets 101 based on the statistical measures chosen for the Utilization Parameters;
determining 206 of Constraining Factor from the chosen statistical measure of the Utilization Parameters over the predetermined time period; and
computing 207 of utilization as a product of Constraining Factor, the unit price (P) of the IT Infrastructure Asset 101 and number of time periods (n) and expressed as a monetary value by a computation module.

6. The method 200 of determining utilization of an Information Technology (IT) Infrastructure Assets as claimed in claim 5, wherein the utilization is computed from statistical measures applied on a single parameter or a group of parameters.

7. The method 200 of determining utilization of an Information Technology (IT) Infrastructure Assets as claimed in claim 5, wherein the utilization of the Information Technology (IT) Infrastructure Assets is determined using the Constraining Factor and the utilization of the IT Infrastructure Asset 101 is presented using a single unit of measurement in the form of a monetary value.
